(19) United States
(12) Patent Application Publication
(10) Pub. No.: US 2004/0174443 A1
(43) Pub. Date: Sep. 9, 2004

(54) System and method for storing of records in a database

(76) Inventor: Steven J. Simske, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/384,485

(22) Filed: Mar. 7, 2003

(51) Int. Cl. H04N 5/76

(52) U.S. Cl. 348/231.3; 348/231.2

(57) ABSTRACT

One embodiment of the invention is a method for indexing an image in a database comprising obtaining an image, obtaining global positioning system (GPS) information for the image, converting the GPS information into at least one waypoint location, and linking the image with at least one other image in the database based on the at least one waypoint location.

### CROSS-REFERENCE TO RELATED APPLICATIONS

The present application is related to copending and commonly-assigned U.S. patent application Ser. No. 10/238,126, entitled “SYSTEM FOR AND METHOD OF GENERATING IMAGE ANNOTATION INFORMATION,” filed concurrently herewith, the disclosure of which is hereby incorporated by reference.

### FIELD OF THE INVENTION

This invention relates in general to computer networks, and relates more particularly to a network-based system and method for enabling users to share location-tagged images.

### DESCRIPTION OF RELATED ART

Current digital cameras incorporate GPS (global positioning system) data into their images. For example, a Kodak Professional DCS digital camera has GPS devices that can be attached to the camera. The GPS-attached camera then records the GPS coordinates in the file headers of the image files, along with the ISO setting, shutter speed, date, and time. Another example is a Casio camera model A3012CA that is a mobile telephone that includes both a camera and GPS receiver. This camera enables a user to take a picture, and the e-mail the picture, along with a map of where the picture was taken, to other people.

At the present time, it is possible to access content on the Internet through any number of mechanisms. The most common mechanism includes utilizing a browser to obtain a web page through a web browser application. A user may access content at websites, discussion groups on the Usenet, or various chat rooms. A user may also access a community, which is a web site on the Internet associated with a common trait or common interest such as a particular topic, subject, or theme. Examples of communities may include a community directed to university students or a community directed to employees of a particular organization. Users can go to the web site and discuss or research a topic. For example, Yahoo.com has several different communities that are organized by area of interest. For example, under the Arts & Humanities section of Yahoo.com, there are approximately twenty-six different categories of communities that a user could choose to visit.

### BRIEF SUMMARY OF THE INVENTION

One embodiment of the invention is a method for indexing an image in a database comprising obtaining an image, obtaining global positioning system (GPS) information for the image, converting the GPS information into at least one waypoint location, and linking the image with at least one other image in the database based on the at least one waypoint location.

Another embodiment of the invention is a system for facilitating communication between users comprising means for entering a record into a database of records that is operable by the users, wherein the record includes GPS information, and the means for entering converts the GPS information into a waypoint location and associates the waypoint location with the record, and means for searching the database by waypoint location.

Another embodiment of the invention is a method for using a database, wherein the database comprises a plurality of records, each of which is indexed in the database by at least one waypoint, the method comprising enabling an input user to store at least one record into the database, associating the at least one record with at least one other record in the database based on the at least one waypoint, and enabling a viewing user to access the database and retrieve at least one record of a plurality of desired records, wherein each record of the plurality of desired records has a same waypoint at the remaining records of the plurality of desired records.

Another embodiment of the invention is a computer-readable medium having computer program logic recorded thereon for storing an image in a database, the computer-readable medium comprising logic for obtaining an image, logic for obtaining global positioning system (GPS) information for the image, logic for converting the GPS information into a waypoint location, logic for storing the image into the database along with the waypoint location, and logic for linking the image with at least one other image in the database based on the waypoint location.

### BRIEF DESCRIPTION OF THE DRAWINGS

FIG. 1 depicts a flow chart showing an embodiment of a method according to the teachings of the invention;

FIG. 2 depicts a first view of the world for providing location information, according to an embodiment of the present invention;

FIG. 3 depicts a second view of the world for providing location information, according to an embodiment of the present invention; and

FIG. 4 depicts a block diagram of a computer system which is adapted to use the present invention.

### DETAILED DESCRIPTION

Embodiments of the invention enable users to share their photos or images with other users. Portions of these embodiments preferably reside on a server that can be accessed by a plurality of users. These portions are hereby referred to herein as a community. Other portions of the embodiments may reside on a computer of the user or may reside in the community. User may use view the images to preview a trip, to recall a previous trip, to enhance an existing portfolio of images, or recreational viewing.

The images are preferably indexed in the community by waypoint information. An inputting user can store their images into a database of the community. Embodiments of the invention convert GPS information associated with the images into waypoint locations. The images of the inputting user are then stored into the community and are indexed by the waypoint information. Viewing users may search the database for images by entering a waypoint location as a search criteria. Viewing users may also elect to have the community send new images associated with particular waypoints to them automatically, as the new images are stored into the database. Viewing users may also elect to receive notification that new images associated with particular waypoints have been entered into the database. Other embodiments of the invention will also operate with documents or other information that has an association with location.

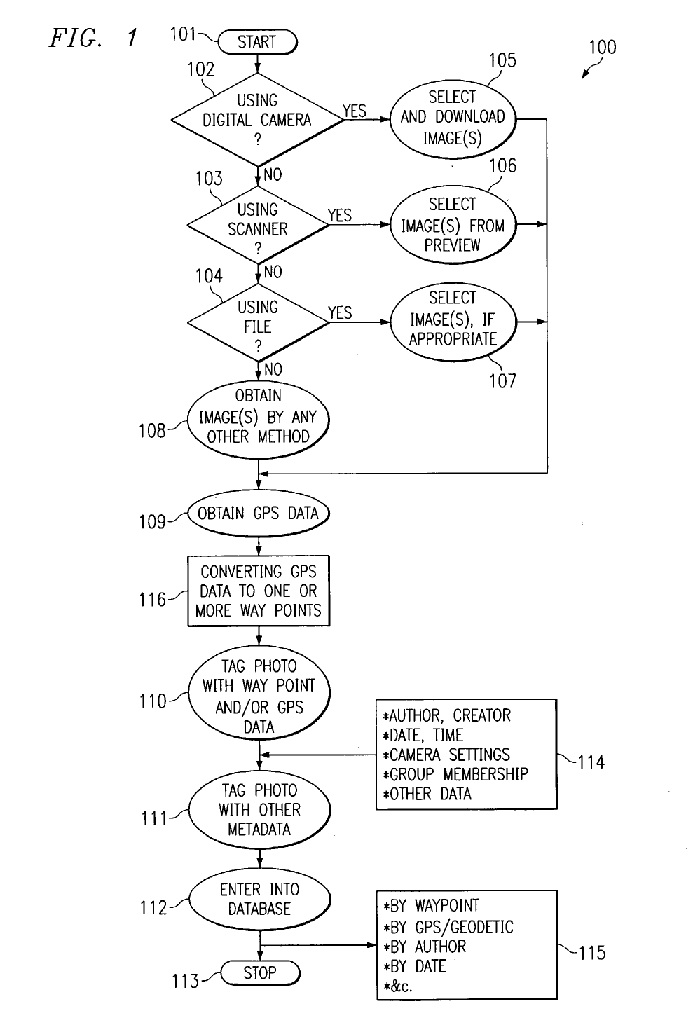

FIG. 1 depicts a flow chart 100 showing an example of an embodiment of the invention. A user preferably starts (101) the process by forming a connection to a server that has access to the community with an image database. For example, in one implementation the user would connect to a website, via his or her Internet service provider, to access a server that comprises the image database. With regards to FIG. 1, the user is going to input images into the community database, and therefore is referred to as the inputting user. A program comprising logic consistent with the teachings of the invention stored on the server would then interact with the inputting user, via the inputting user's browser. Note that the image may be in a variety of well-known data formats, such as TIFF (tag image file format), JPEG joint photographic experts group), PDF (portable document format), PICT (Apple image format), PNG (portable network graphics), GIF (graphics interchange format), XML+CSS/XSLT (extensible markup language+cascading style sheets/extensible style language transformations). Other formats now known or later developed may be used in other embodiments of the invention.

The program determines the source of the image(s) to be entered into the database. The program may query the inputting user as to the source of the image by providing the inputting user with a list of possible choices, whereby the inputting user would select the proper source of the image.

Alternatively, the program may determine the source of the image. The program may determine (102) whether the source is a digital camera. If so, then the user selects the (105) image(s) for downloading to the database. The inputting user may select one or more particular images from a preview window. The inputting user may instead download all images stored in the camera. Note that this presumes that the digital camera is communicatively connected to a computer or docking device that has access to the database. The digital camera may be typical digital camera, or a camera that is combined with another device, such as a telephone or a binocular.

If the source of the image(s) is not a digital camera, the program (103) determines whether the source is a scanner. If so, then the inputting user selects (106) the image(s) for downloading to the database. For example, the inputting user may use the preview window to select and download images. Note that this presumes that the scanner is automatically connected to a computer that has access to the database. The inputting user may select one or more particular images from a preview window. The inputting user may instead download all images scanned by the scanner. The scanner may be a hand-held scanner, a desk-top scanner, a facsimile, a copy machine, or a multifunction device that has scanning as a function.

If the source of the image(s) is also not a scanner, the program determines whether the source is a file (104). If so, then the inputting user selects (107) the images for downloading to the database. For example, the inputting user may select a file that comprises the image(s) from a directory. Note that this presumes that the file is accessible by a computer that has access to the database. The file may be an image file in an e-mail message, downloaded from a website, or located on a hard drive, an optical disc, a floppy disk, a portable memory device, or a handheld computer, just to name a few.

If the source of the image(s) is also a file, the program obtains (108) the image from other sources. In this block, the inputting user would specify the source of the image. For example, the image may be an image located in a program, such as an image editor.

Note that various embodiments of the invention can make the source determination in any order. Some embodiments may also present all of the choices to a user simultaneously, e.g. by having a selection screen that provides source choices to the user. Some embodiments may instead sense the device communicatively connected to the computer the user is employing and only offer those related choices, or ask the user to connect the source device having the desired image(s). Some embodiments may offer a subset of the choices associated with boxes 102, 103, 104.

After selection of the source and downloading of the image(s), the program proceeds to obtain GPS data. For cameras that incorporate GPS, the GPS data may already be associated with the image as metadata, for example DIG35 (digital imaging group) or EXIF (exchangeable image file format) formats include GPS data as metadata. Metadata is a descriptive header that is associated with the image file. The metadata may be incorporated as part of the image file, e.g. where the metadata is located at the beginning of the image, or metadata may be stored separately from the image and associated with the image via a tag or pointer. Alternatively, the inputting user would obtain the GPS data from the camera, or other source, e.g. a GPS device, a map, or a database. As a further alternative, the inputting user would enter as much data for this location as is known, and the program would form a GPS location for the text location. For example, an inputting user could enter a city and corner name (e.g. Anytown, USA, and South State Street and East Liberty Lane), or a city name and a street address (e.g. Anytown, 500 South State Street) and the program would form a GPS location from an existing database.

Yet another alternative is to automatically generate image location information as disclosed in U.S. patent application Ser. No. 10/238,126, entitled “SYSTEM FOR AND METHOD OF GENERATING IMAGE ANNOTATION INFORMATION.”

After obtaining the GPS data, the program converts (116) the GPS data to a waypoint location. Waypoints are preferred, because a waypoint associates the location with other text entries and constitute broader descriptions of locations than a GPS reference. For example, an object of the image (e.g. a mountain) may be located distant from the camera location, and thus a GPS location of the camera may not adequately describe the location of the content of the image. Thus, an object may be located closer to another waypoint than to the actual GPS location of the camera. For example, “Mammoth Mountain” may be a better description of the image captured by the camera, rather than “Mammoth Mountain Village” which would be derived from the actual GPS location of the camera.

The program preferably performs the conversion by comparing the GPS data to waypoint information in a pre-existing list of waypoints to determine which waypoint or group of waypoints is the nearest to the GPS data. The following formula is an example of a way for the program to determine which waypoint is appropriate for the image.

Waypoint Difference=sqrt((Δx)²+(Δy)²+(Δz)²)

where Δx is the difference in latitude, Δy the difference in longitude, and Δz the difference in geodetic height between the GPS information and any waypoint in the pre-existing list of waypoints. If the waypoint difference is less than or equal to a predetermined number, then the waypoint is near to the GPS data of the image.

After obtaining the waypoint information, the image is preferably tagged (110) with the waypoint location and/or GPS information. This can be readily accomplished by conformance to a XML schema such as the following. Note that geodetic data is used in this example, along with the name of the image and its universal resource location (URL). It will be appreciated that the following is only an example embodiment of the invention.

<?xml version=“1.0” encoding=“UTF-8”?>
<xsd:schema xmlns:xsd=‘http://www.w3.org/2001/XMLSchema’>
<xsd:schema>
<xsd:element name=“GeodeticTaggedImage”>
<xsd:complexType>
<xsd:element name=“Image Name” type=‘string’ minOccurs=‘1’
maxOccurs=‘1’>
<xsd:element name=“Image URL” type=‘string’ minOccurs=‘1’
maxOccurs=‘1’>
... <!—other information about the image can be represented here -->
<xsd:element name=“Location Name” type=‘string’ minOccurs=‘0’
maxOccurs=‘unbounded’>
<xsd:element name=“GPS Data”>
<xsd:complexType>
<xsd:element name=“longitude” type=‘float’ minOccurs=‘1’
maxOccurs=‘1’/>
<xsd:element name=“latitude” type=‘float’ minOccurs=‘1’
maxOccurs=‘1’/>
<xsd:element name=“height” type=‘float’ minOccurs=‘1’
maxOccurs=‘1’/>
</xsd:complexType>
</xsd:element>
</xsd:complexType>
</xsd:element>
</xsd:schema>

Using the above example of schema will result in an XML file such as:

```
<GeodeticTaggedImage>
    <Image Name>MyHouse103.jpg</Image Name>
    <Image URL>http://gpsImages.hp.com/MyName/MyHouseFiles
    </Image URL>
. . . <!—other information about the image can be represented here -->
    <Location Name>Side view of my new addition</Location Name>
    <GPS Data>
        <Longitude>xxx.xxx</Longitude>
        <Latitude>xxx.xxx</Latitude>
        <Height>xxx.xxx</Height>
    </GPS Data>
</ GeodeticTaggedImage>
```

Note that the “Location Name” element is not required. It will also be appreciated that the Image Name and Image URL can be automatically provided by the server in which the image is to be stored. The GPS Data can be extracted into a separate database from the image or stored along with the image.

The image may also be tagged with a waypoint or a group of waypoints. Given a relevant list of waypoints, the XML schema above can be modified to include information on the nearest waypoint as shown in the following portion of a schema.

<xsd:element name=“Waypoint”>
<xsd:complexType>
<xsd:element name=“Location Name” type=‘string’ minOccurs=‘1’
maxOccurs=‘unbounded’>
<xsd:element name=“GPS Data”>
<xsd:complexType>
<xsd:element name=“longitude” type=‘float’ minOccurs=‘1’
maxOccurs=‘1’/>
<xsd:element name=“latitude” type=‘float’ minOccurs=‘1’
maxOccurs=‘1’/>
<xsd:element name=“height” type=‘float’ minOccurs=‘1’
maxOccurs=‘1’/>
</xsd:complexType>
</xsd:element>
</xsd:complexType>
</xsd:element>

The above schema may include at least one waypoint. The above schema may also include at least one GPS location associated with the image. Multiple GPS locations associated with the image might include, for example, GPS location of the camera, and one or more GPS locations for one or more objects in the image.

The image may be tagged (111) with other metadata. Information (114) such as the author or creator, date, time, exposure settings, camera settings, group membership (e.g. interested viewers), comments, keywords, etc. can be associated with the image as well as waypoint location(s), GPS location(s), a GPS location of the camera capturing the image, and/or GPS location(s) of an object in the image. Note that block 111 may occur before, after, or contemporaneous with block 1 10. Such information may be included in the “<!—other information about the image can be represented here →” section of the schema above. This information can be automatically or manually entered. For example, if the user has an ID, password and/or profile on the database server, metadata about the author can be automatically entered. Other information can be entered using standard dialogs, forms, controls or other UI (user interface) tools. Applets, forms, pop-up menus, and right-clicking are all suitable ways of entering this information.

After any other metadata has been associated with the image, the image is then entered (112) into the database. The image is preferably linked with other images in the database based on waypoint location. Thus, images that have the same waypoint are linked together. However, embodiments of the invention will operate with geodetic or GPS data. Using the following equation, the input image can be linked to the nearest images in the database by GPS data in terms of Cartesian coordinates.

Image Difference=sqrt((Δx)²+(Δy)²+(Δz)²

where Δx is the difference in latitude, Δy the difference in longitude, and Δz the difference in geodetic height between the one image and another image in the database. If the image difference is less than or equal to a predetermined number, then the input image is linked to the image or images of the comparison. Note that other linking mechanisms could be used. For example, K-mean, EM (expectation maximization) or KL (Kullback-Leibler) divergence clustering techniques could be used to associate images with each other. Images can be linked together by adding schema fields for linked images to the particular image. The following is an example of such schema fields.

<xsd:element name=“Linked Image” type=‘string’ minOccurs=‘0’
maxOccurs=‘unbounded’/>
<xsd:complexType>
<xsd:element name=“Image Name” type=‘string’ minOccurs=‘1’
maxOccurs=‘1’>
<xsd:element name=“Image URL” type=‘string’ minOccurs=‘1’
maxOccurs=‘1’>
</xsd:complexType>
</xsd:element>

Note that separate listing of “Image Name” and “Image URL” elements is preferred. For example, passwords and user identification may be part of the metadata sent along with the image. The URL may be the level at which a password is required, and the Image Name is the additional location information a computer employs to store the image appropriately. For example, suppose the images are uploaded to a sit called www.photosforoneandall.org, and at this URL, a password and user ID are required for entry. The password and user ID may be provided by metadata. The inputting user, Ish K. Bibble, stores his images onto his directory, such as IshKBibble/vacation2002/image1.jpg, etc. Thus, the full URL is actually www.photosforoneandall.org/IshKBibble/vacation 2002/image1.jpg, but it may be pieced together from the Image URL+Image Name. In some cases, the Image Name may be empty, e.g. www.photosforoneandall.org/welcome.jpg.

After entry into the database, the entry process is complete (113), and the entered image may now be retrieved along with similar images by viewing users. Note that the image may be stored in a variety of well-known data formats, such as TIFF, PICT, PDF, JPEG, PNG, GIF, or XML+CSS/XSLT. Other formats now known or later developed may be used in other embodiments of the invention. The image can be retrieved by searching for any of the metadata associated with the image, including by location, e.g., waypoints, GPS and/or geodetic formats.

Embodiments of the invention enable a user to search the database by waypoint location information, geodetic information, GPS location of the camera, camera angle, GPS location of an object in the image, date, time, author, exposure settings, camera setting, or any other information with which the images are tagged. Note that the search may be a Boolean search involving one or more terms and/or one or more types of information. The program may present the images to the users in different forms, e.g. thumbnails, directory with thumbnail of highlighted image; a tree of the images, etc.

Embodiments of the invention can be used to support a plurality of inputting users, as well as, a plurality of viewing users. Each inputting user can upload and download their files to the community. Viewing users can subscribe to various messages from the community. For example, a viewing user may desire to receive notification when a particular inputting user has posted new images, or when a waypoint has new linked images. As another example, a viewing user may desire to receive notification when a group of waypoints has new linked images (for example a large location such as a national park may have several waypoints associated with it), or when a specified GPS/geodetic location has new images. The viewing user may also elect to have the images e-mailed directly to him, instead of or in addition to receiving notification. In the e-mail, the images may be presented in an original size or format, in a thumbnail format, or compressed (e.g. in a ZIP file). A viewing user may select one or more metadata of interest. Some embodiments enable an inputting user to select which viewing users will receive notification and/or the actual images when the inputting user enters the images into the database. Note that an inputting user may also be a viewing user and vice versa.

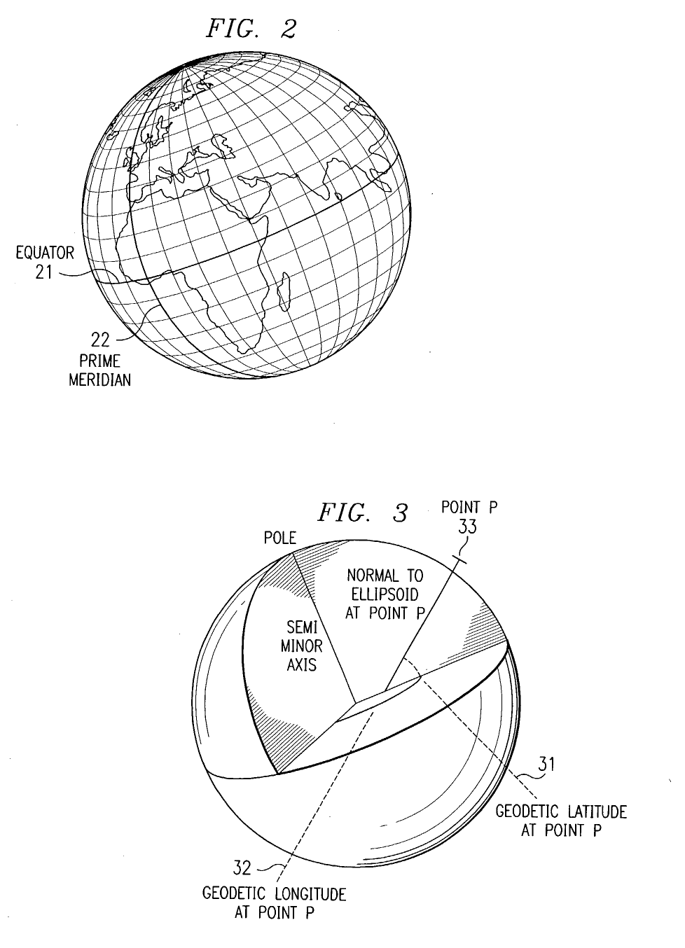

FIGS. 2 and 3 show two views of the world used in forming location information according to embodiments of the present invention. In FIG. 2, a particular location on the surface of the Earth may be described by reference to that location's distance north or south from equator 21. This is known as the location's latitude. The location's distance east and west of prime meridian 22, that runs through Greenwich, Great Britain, is known as the location's longitude. In FIG. 3, a location may be described using geodetic XYZ coordinates, that describe a location in terms of its latitude, longitude, and height. A geodetic system describes a point in terms of geodetic latitude 31, geodetic longitude 32, and geodetic height 33. A three-coordinate system as shown in FIG. 3 may include locations above and below the earth's surface that the two-coordinate system shown in FIG. 2 is unable to quantify.

When implemented in software, elements of those embodiments of the present invention are essentially the code segments to perform the associated tasks. The program or code segments can be stored in a processor readable medium or transmitted by a computer data signal embodied in a carrier wave, or a signal modulated by a carrier, over a transmission medium. The “processor-readable medium” may include any medium that can store or transfer information. Examples of processor-readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, and other mediums now known or developed in the future. The computer data signal may include any signal that can propagate over a transmission medium such as electronic network channels, optical fibers, air, electromagnetic, RF links, etc. The code segments may be downloaded via computer networks such as the Internet, intranet, etc.

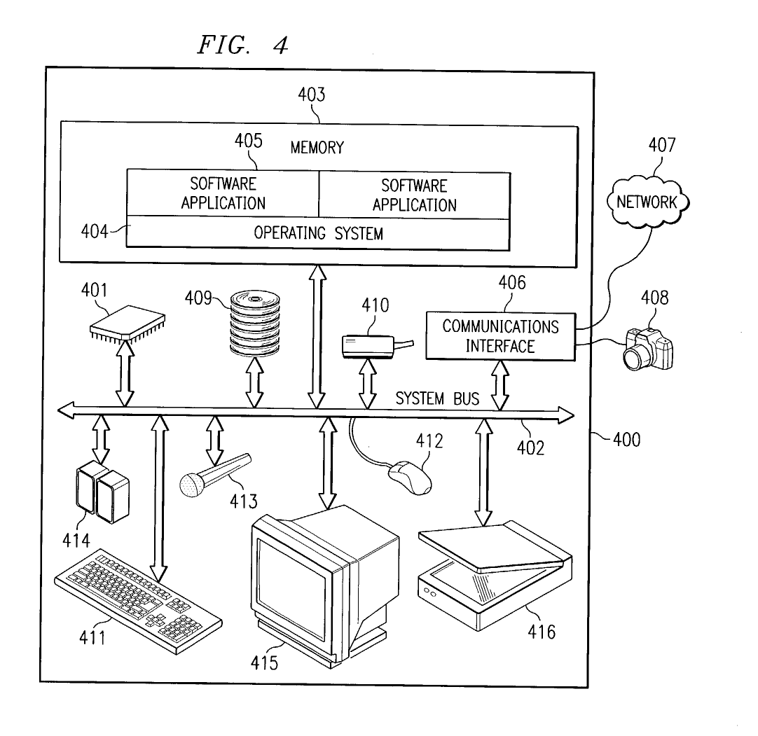

FIG. 4 illustrates computer system 400 adapted to use the present invention. This computer system comprises a server that contains the database of images into which a user enters images. This computer system may also comprise a computer of a user who is connected to the server that contains the images via a network. Central processing unit (CPU) 401 is coupled to system bus 402. The CPU 401 may be any general purpose CPU; the present invention is not restricted by the architecture of CPU 401 as long as CPU 401 supports the inventive operations as described herein. Bus 402 is coupled to memory 403, which may be random access memory (RAM), including SRAM, DRAM, or SDRAM. Memory 403 may also include read-only memory (ROM), including PROM, EPROM, or EEPROM. The memory holds user and system data, as well as operating system 404 and software application 405 programs, as is well-known in the art.

Bus 402 is also coupled to communications interface 406. Communications interface 406 is adapted to couple the computer system 400 to a network 407, which may be one or more of a telephone network, a local (LAN) and/or a wide-area (WAN) network, an Ethernet network, and/or the Internet network. Communication interface also enables a user to communicatively connect peripheral devices 408, such as a camera, to the computer system 400 to upload data to or download data from the device 408. For example, a user could download images from a camera. The images could then be stored in the computer system or sent out onto the network. The interface may use a wire, infrared, wireless or other type of communicative connection.

Bus 402 is also connected to storage device 409. The storage device could comprise multiple storage devices, such as at least one of a hard drive, a CD (compact disc) drive, a floppy disk drive, a tape drive, and a DVD (digital video disc or digital versatile disc) drive. Bus 402 is also connected to various input and output devices. For example, printer 410, would enable the system to print paper copies of information such as document, photographs, articles, etc. Note that the printer may a printer (e.g. dot matrix, laser, etc.), a fax machine, or a copier machine. User input devices such as keyboard 411, pointing device 412, and microphone 413 are also connected to bus 402. Speakers 414 enable a user to hear sounds generated by the computer system 400. Display device 415 enables a user to view images produced by the computer system 400. Additional devices 416, for example a scanner, may be connected to the bus 402.

Note that images include video images as well as still images. Further note that the invention has been described in terms of images, but can operate with any type of record that has a location-based aspect. For example, poetry, novels, or other written works may be used with embodiments of the invention to associate waypoint information with the work. Note that the written work may in stored and accessed in image format, e.g. a PDF (portable document format) file. A database of the works would have each work tagged with one or more waypoints. Thus, a viewing user could search the database for written works that involve “the Alamo.” An inputting user would place a work into the database and then tag the work with a waypoint. Embodiments of the invention may also work with video information. A database of the video files would have each video file tagged with one or more waypoints. Thus, a viewing user could locate video signals that involve or show “The Alamo.” An inputting user would place a video file into the database and then tag the video file with a waypoint. Other embodiments may also operate with sound, travel information, weather, maps and/or documents by tagging the object file with one or more waypoint tags. A database of the object files would have each object file tagged with one or more waypoints. Thus, a viewing user could locate the object file that involves “The Alamo.” An inputting user would place an object file into the database and then tag the object file with a waypoint.

The community may be operated as an electronic service or e-service. This service would encourage users to use digital photography and/or other forms of digital imaging. Moreover, having the large amount of images stored at one location will cause users to favor the web site with the service over other picture-posting sites, thereby increasing the potential advertising revenue for the web site. The service may be offered free of charge (or at a reduced rate), for at least a limited time, to customers (both inputting users and viewing users) that purchase a product, e.g. a digital camera, from the owner of the community. After a predetermined time period, the customer may have to pay for the service. Existing users that recruit new users may receive a bonus in terms of a rate reduction and/or extended service. Inputting users and/or viewing users may also be charged a fee to the access to the service. For example, a viewing user may be charged for each picture viewed, and an inputting user may be charged for the space required for storing their images on the database. As another example, an inputting user may be allowed to store up to a certain amount of images for free (e.g. 5 megabytes), and then be charged to store a greater amount of images. Viewing users may have free access to the database, but may be charged for the notification and/or automatic delivery of images. As another example, inputting users may input their images for free, but are charged for any image editing that they may do. Viewing users may receive thumbnail sized images for free, and are charged for larger image sizes. As another example, the service may be offered free to both the inputting user and the viewing user. Other examples may use various combinations and/or modifications of the above.

What is claimed is:

1. A method for indexing an image in a database comprising:
obtaining an image;
obtaining global positioning system (GPS) information for the image;
converting the GPS information into at least one waypoint location; and
linking the image with at least one other image in the database based on the at least one waypoint location.

2. The method of claim 1, further comprising:
storing the image and the at least one waypoint location into the database.

3. The method of claim 1, wherein obtaining the image comprises:
selecting a source from the group consisting of a digital camera, a scanner, and a file.

4. The method of claim 1, further comprising:
associating the GPS information with the image.

5. The method of claim 1, further comprising:
associating, by a source of the image, the GPS information with the image.

6. The method of claim 1, further comprising:
associating other information with the image, wherein the other information is at least one of: author, date, time, an image creation setting, a comment, a keyword, and an interested viewer of the image.

7. The method of claim 5, further comprising:
searching the database employing at least one of: waypoint location, GPS information, author, date, time, an image creation setting, a comment, a keyword, and an interested viewer of the image.

8. The method of claim 1, wherein converting further comprises:
converting a GPS location into at least one waypoint location.

9. The method of claim 1, wherein converting further comprises:
converting a plurality of GPS locations into at least one waypoint location.

10. The method of claim 8, wherein:
converting a GPS location of a camera that formed the image and a GPS location of an object in the image into at least one waypoint location.

11. The method of claim 1, wherein the converting comprises:
providing a list of waypoints;
determining a difference between each waypoint of the list and the GPS information; and
selecting a waypoint from the list when the difference is less than or equal to a predetermined value.

12. A system for facilitating communication between users comprising:
means for entering a record into a database of records that is operable by the users, wherein the record includes GPS information, and the means for entering converts the GPS information into a waypoint location and associates the waypoint location with the record; and
means for searching the database by waypoint location.

13. The system of claim 12, wherein:
the means for entering associates other information with the record, wherein the other information is at least one of: author, date, time, a record creation setting, a comment, a keyword, and an interested viewer of the record.

14. The system of claim 12, wherein:
the means for searching searches the database by at least one of: GPS information, author, date, time, a record creation setting, a comment, a keyword, and an interested viewer of the record.

15. The system of claim 12, wherein the means for entering a record comprises:
means for entering a record, wherein the record has a type that is selected from the group consisting of: image, text, video, and audio.

16. A method for using a database, wherein the database comprises a plurality of records, the method comprising:
associating at least one record with at least one other record in the database based on at least one waypoint, wherein each record is indexed in the database by at least one waypoint; and
enabling a viewing user to access the database and retrieve at least one record of a plurality of desired records, wherein each record of the plurality of desired records has a same waypoint.

17. The method of claim 16, further comprising:
enabling an input user to store at least one record into the database.

18. The method of claim 16, further comprising:
enabling said viewing user to automatically receive at least one image associated with a particular waypoint subsequent to the at least one image being stored into the database.

19. The method of claim 16, further comprising:
automatically notifying said viewing user that at least one image associated with a particular waypoint has been stored into the database.

20. The method of claim 16, further comprising:
enabling said viewing user to select to receive at least one notification that at least one image associated with a particular waypoint has been stored into the database and to receive at least one image.

21. The method of claim 16, wherein enabling an input user to store at least one record into the database comprises:
enabling said input user to store at least one record into the database, wherein the record has a type that is selected from the group consisting of: image, text, video, and audio.

22. The method of claim 16, further comprising:
charging a fee to at least one of the inputting user and the viewing user to allow access to the database.

23. A computer-readable medium having computer program logic recorded thereon for storing an image in a database, the computer-readable medium comprising:
logic for obtaining an image;
logic for obtaining global positioning system (GPS) information for the image;
logic for converting the GPS information into a waypoint location;
logic for storing the image into the database along with the waypoint location; and
logic for linking the image with at least one other image in the database based on the waypoint location.

24. The computer-readable medium of claim 23, further comprising:
logic for searching the database of images by waypoint location.

25. The computer-readable medium of claim 23, further comprising:
logic for associating other information with the image, wherein the other information is at least one of: author, date, time, an image creation setting, a comment, a keyword, and an interested viewer of the image.

26. The computer-readable medium of claim 23, further comprising:
logic for searching the database by at least one of: waypoint location, GPS information, author, date, time, an image creation setting, a comment, a keyword, and an interested viewer of the image.

27. A method of exchanging image files with a community of users, comprising:
storing at least one image to a database on a commonly-available server, wherein at least one image is associated with the at least one waypoint;
searching said database for images associated with a selected waypoint;
creating a list of one or more images associated with said selected waypoint;
displaying said list of a user;
downloading one or more selected images on said list to said user from the database.

28. The method of claim 27 further comprising:
establishing a user account for each user in said community of users.

29. The method of claim 28 further comprising:
charging a first user's account each time said first user stores an image to said database.

30. The method of claim 28 further comprising:
charging a first user's account each time said first user downloads a selected image from said database.

31. The method of claim 27 further comprising:
notifying particular ones of said community of users when at least one image associated with at least one preselected waypoint is stored to said database.

32. The method of claim 27 further comprising:
displaying thumbnail versions of the images associated with the selected waypoint.
